(19) United States
(12) Patent Application Publication
(10) Pub. No.: US 2015/0374014 A1
(43) Pub. Date: Dec. 31, 2015

(54) AERATED PET TREAT

(71) Applicant: Mars, Incorporated, McLean, VA (US)

(72) Inventors: Vinod Gumudavelli, McLean, VA (US); Francis Shields, McLean, VA (US)

(21) Appl. No.: 14/849,445

(22) Filed: Sep. 9, 2015

Related U.S. Application Data
(63) Continuation of application No. PCT/US2014/026878, filed on Mar. 13, 2014.
(60) Provisional application No. 61/793,152, filed on Mar. 15, 2013.

(51) Int. Cl. A23K 1/18; A23K 1/00; A23K 1/16

(52) U.S. Cl. CPC A23K 1/1853; A23K 1/1631; A23K 1/1643; A23K 1/001

(57) ABSTRACT

The present invention provides for an aerated pet treat and a method for weight loss or weight control in pets. The aerated pet treat is preferably low in calories and fat, thus a low calorie pet treat and a low fat treat are also provided. The aerated pet treat is especially attractive to cats.

### FIELD OF THE INVENTION

The present invention is related to aerated pet treats and methods for controlling weight and weight loss in pets. More particularly, the present invention is related to an aerated pet treat that is low in calories and fat. Further, a method of controlling weight in a pet and a method for weight loss are also provided.

### BACKGROUND

Obesity in pets is a growing problem, as treats, cookies, and other pet confections are widely available. An estimated 60% of cats in the United States are overweight, roughly 50 million, with 40% of those animals being obese. Overweight and obese animals are at a much higher risk of developing osteoarthritis, insulin resistance and type 2 diabetes, high blood pressure, heart and respiratory disease, cranial cruciate ligament injury, hepatic lipidosis, kidney disease, and many forms of cancer. Additionally, it is estimated that being overweight decreases life expectancy up to 2.5 years.

Most of the treats in the art are meat-based treats, which are often high in calories, fat, and sodium. Some of these types of treats include pet jerky, meat filled treats, meat filled rawhide, and the like. Consumption of treats, such as these, in addition to a normal pet diet, easily leads to caloric consumption beyond recommended daily allowances. Additionally, these treats are dense in weight and calories, thus consumption of only a few treats can lead to a great increase in caloric intake. It is estimated that a 10 lb. cat should consume 180-200 calories per day.

What is needed in the art is a low calorie, low fat treat that is attractive to pets. Further, what is needed is a method of controlling weight and a method for weight loss that incorporates low calorie, low fat treats that are attractive and satisfying for pets.

### SUMMARY OF THE INVENTION

The present invention overcomes the problems inherent in the prior art and provides for a distinct advance in the art. The treat of the present invention is an aerated pet treat preferably comprising a protein source and a carbohydrate. Such a treat is preferably low in calories and/or low in fat, therefore, aspects of the present invention are directed to a low calorie treat, a low fat treat, and a low calorie, low fat treat. Additionally, the treat is preferably aerated, so the treat has low density which helps the low calorie nature of the treat. Advantageously, treats in accordance with the present invention can comprise a dual texture as well as teeth cleaning treat attributes. Consumption of treats in accordance with the present invention can be used to help control pet weight as well as helping pets to lose weight.

The aerated pet treat of the present invention is preferably comprised of a protein source and a carbohydrate, wherein the ingredients are aerated such that small bubbles form within the matrix of the treat. The air bubbles preferably comprise at least 10% of the matrix of the treat, more preferably at least 20% of the matrix of the treat, still more preferably at least 30% of the matrix of the treat, still more preferably at least 40% of the matrix of the treat, even more preferably at least 50% of the matrix of the treat, more preferably at least 60% of the matrix of the treat, more preferably at least 70% of the matrix of the treat, more preferably at least 80% of the matrix of the treat, and most preferably at least 90% of the matrix of the treat.

Preferably, there are at least 11 bubbles per mm² of treat, more preferably from at least 11 to at least 15, still more preferably from 11 to at least 20, still more preferably from 11 to at least 23, even more preferably from 11 to at least 25, and still more preferably from 11 to at least 30 bubbles per mm². Alternative, there are preferably at least 121 bubbles per mm³, more preferably at least 121 to at least 225, still more preferably from 121 to at least 400, more preferably from 121 to at least 625, and still more preferably from 121 to at least 900 bubbles per mm³. The bubbles are preferably small in diameter. It is appreciated that the amount of bubbles relative to the mass of the treat is directly related to the density of the aerated pet treat, thus, the density can be adjusted within a wide range. In order to take the most advantage of the density's effect on weight loss or control, it is preferred that the density be low.

The protein source and carbohydrate source are preferably aerated such that the resulting treat has a low density, giving it a light and airy texture. Preferably, the bulk density is less than about 0.5 g/cc, more preferably from about 0.5 g/cc to 0.1 g/cc, even more preferably from about 0.45 g/cc to 0.15 g/cc, still more preferably from about 0.4 g/cc to 0.2 g/cc, and most preferably from about 0.345 g/cc to 0.284 g/cc. Notably, the density of the pet treat of the present invention is lower than any other treat currently available in the art.

In preferred forms, the pet treat will have a low caloric density. Preferably the caloric density will be from about 2.5 to 5.5 calories per gram weight, more preferably from about 3.0 to 5.0 calories per gram, still more preferably from about 3.0 to 4.5 calories per gram weight, and most preferably about 3.1 calories per gram. The caloric density can vary depending on bubble size within each treat. Preferably, each treat weighs less than 1 gram, thus making the treat of the present invention normal size by industry standards, but having a lower calorie content that treats of similar overall size.

The moisture content of the aerated pet treat is preferably less than about 15% by weight in the final product, more preferably less than about 12% by weight, still more preferably between about 1% to than 11% by weight, even more preferably between about 3% to 10% by weight, still more preferably less than about 9% by weight, even more preferably between about 4% to 9% by weight, even more preferably about 5% to 8% by weight, and most preferably about 7.6% by weight.

The aerated treat of the present invention is preferably low in calories, thus one aspect of the present invention provides for a low calorie treat. Preferably, the low calorie treat has between 0.001 and 1 calorie(s) per treat, more preferably between 0.01 and 0.5 calories, still more preferably between 0.015 and 0.45 calories, more preferably between 0.02 and 0.4 calories, still more preferably between 0.025 and 0.3 calories, and most preferably, between 0.03 and 0.15 calories. The calories of the treat are based on the weight of the treat. Preferably, each low calorie treat weighs less than 0.5 grams per treat, more preferably between 0.5 and 0.001 g, still more preferably between 0.45 and 0.003 g, even more preferably between 0.4 and 0.005 g, still more preferably between 0.35 and 0.007 g, even more preferably between 0.3 and 0.01 g, even more preferably between 0.25 and 0.03 g, still more preferably between 0.2 and 0.04 g, even more preferably between 0.15 and 0.05 g, still more preferably between 0.1 and 0.05 g, and even more preferably between 0.01 and 0.05 g per treat.

The aerated treat of the present invention is preferably low in fat, thus another aspect of the present invention provides for a low fat treat. Preferably, the fat content is less than about 5% by weight, more preferably from about 5% to 1% by weight, even more preferably from about 4% to 1.5% by weight, still more preferably from about 3.5% to 2% by weight, and most preferably about 2.5% by weight.

The protein content of the aerated treat of the present invention is preferably at least 20% by weight, still more preferably at least 30% by weight, even more preferably at least 40% by weight, still more preferably at least 45% to 90% by weight, even more preferably at least 50% to 85% by weight, and most preferably, at least 51% to 80% by weight.

The protein source for the aerated pet treat is preferably selected from, but not limited to, egg whites, gelatin, animal plasma, whey protein, canola protein, canola protein isolates, pea protein, pea protein isolate, soy protein, and combinations thereof. Of those protein sources, egg white is especially preferred. The protein source preferably makes up about 4.5% to about 40% by weight of the composition of the aerated pet treat prior to heating, more preferably from about 8% to about 35% by weight, still more preferably from about 12% to about 30% by weight, even more preferably from about 14% to about 28% by weight, and most preferably between about 15% to about 26% by weight.

The carbohydrate source for the aerated pet treat is preferably selected from, but not limited to, sugar, corn syrup, dextrose, glycerin, hydrocolloids (starches, gums,), flour, hydrogenated starch hydrolysate, and combinations thereof. The carbohydrate source preferably makes up about 4.5% to about 20% by weight of the composition of the aerated pet treat pre-heating, more preferably from about 5% to about 18% by weight, still more preferably from about 8% to about 16% by weight, even more preferably from about 8.5% to about 12% by weight, and most preferably about 9% by weight.

In an additionally preferred embodiment, the aerated treat of the present invention preferably comprises a protein, a carbohydrate, and a liquid. The liquid can be any liquid suitable for forming an aerated pet treat. In a preferred embodiment, the liquid should be able to mix with other ingredients, in particular the dry ingredients. Preferably the liquid is selected from, but not limited to water, glycerin, propylene glycol, sugar syrup (corn syrup, hydrogenated starch hydrolysate, glucose syrup), raw egg white, and combinations thereof. Prior to heating, the liquid preferably comprises from about 30% to about 80% by weight of the aerated pet treat, more preferably from about 40% to about 70% by weight, still more preferably from about 50% to 65% by weight, and most preferably about 60% to 63% by weight.

In preferred forms of the present invention, the aerated pet treat comprises additional components, other than a protein source, a carbohydrate source, and a liquid. Those additional components can be stabilizers, preservatives, palatants, flavor enhancers, and combinations thereof. Preferably, the additional components are selected from, but not limited to, corn starch, xanthan gum, tartaric acid, wheat flour, tapioca starch, milk powder, and combinations thereof.

In a preferred embodiment, the aerated pet treat of the present invention comprises, prior to heating, from about 4.5% to 20% protein, 4.5% to 20% carbohydrate, 30% to 80% liquid, and 20% to 60% other ingredients. Preferably, the protein is egg white, the carbohydrate is glycerin, the liquid is water, and the other ingredients include a flavorant, a preservative, and a stabilizer. In an additionally preferred embodiment, the other ingredients include, but are not limited to gelatin; flour, including any type of flour that does not contain fat; any starch source, including corn starch and tapioca starch; skim milk powder; lactose free milk powder, gums, including xanthan gum; tartaric acid, and combinations thereof. The resulting aerated pet treat preferably contains at least 51% protein at least 2.5% fat, less than 0.5% fiber, and less than 7.6% moisture. In an alternate embodiment, where the resulting aerated pet treat is semi-moist, the resulting aerated pet treat preferably contains at least 45% protein, at least 2.5% fat, less than 0.5% fiber, and less than 15% moisture.

Advantageously, the aerated pet treat has increased palatability for cats when compared to other commercial cat treats. In other words, when given a choice between a treat made in accordance with the present invention and other treats, not made in accordance with the present invention, cats are more likely to choose the pet treat of the present invention, with some cats biting through barriers in order to gain access to the aerated treats of the present invention. When compared with commercial treats, cats consumed at least twice and in some cases, more than three times the number of the pet treats of the present invention than some other commercial treats. Further, cats that tried treats made in accordance with the present invention consumed almost all of the available treats. Thus, the aerated pet treat of the present invention has high palatability for cats.

In a preferred embodiment, a palatant is added to the pet treat. This is preferably accomplished prior to the heating step, but a palatant may be added after the heating step also. Palatants include any palatants utilized in the industry for pet treats.

In some forms, the aerated pet treat preferably has a dual texture aspect. The dual texture treat of the present invention preferably has two layers, where the outer layer preferably has a hard, crunchy texture and the inner layer preferably has a squishy, spongy, soft texture. The squishy, soft inner layer is preferably the consistency of a sponge, having air bubbles therein that retract when compressed and expand when not compressed. The outer layer is preferably a rigid, crunchy layer that breaks apart when consumed. The dual texture of the treat is especially attractive for cats. Alternatively, the aerated pet treat may have either a soft or dry outer texture and an inner texture that is a cream like substance in the center.

Advantageously, the aerated treat of the present invention has the capacity to be a teeth cleaning treat. The teeth cleaning treat of the present invention preferably has an inner layer and an outer layer Preferably, the teeth cleaning aspect of the treat comes from the crunchy outer layer in either an embodiment of the treat with a spongy inner layer or a creamy inner layer. When a pet consumes the aerated treat, the crunchy surface area of the treat comes into frictional contact with the teeth of the pet, thereby removing plaque and other food particles on the pet's teeth. Preferably, the outer layer of the treat remains in contact with the surface of a tooth for at least 20% of the closing mastication movement of a bite prior to detaching from said treat body, more preferably for at least 25% of the closing mastication movement, still more preferably for at least 30% of the closing mastication movement, even more preferably for at least 35% of the closing mastication movement, and most preferably, for at least 40% of the closing mastication movement.

Treats made in accordance with the present invention are generally made by whipping or aerating a composition comprising a protein source and a sugar source so that air bubbles form, dropping said whipped composition onto a surface in small portions, and heating the small portions such that the composition stabilizes resulting in a cooked treat. Other ingredients, such as those provided above, can also be added to the mixture during or prior to the whipping or aerating process.

A method for controlling (or stabilizing) weight or stopping weight gain is also provided as an additional aspect of the present invention. The method generally comprises the step of administering the aerated pet treat of the present invention to an animal in need thereof. Preferably, the aerated treat of the present invention will be substituted for at least some of the other treats that would have normally been provided to the animal. The aerated pet treat preferably has a protein content of at least 51% and preferably less than 5 calories per gram weight. Consumption of the aerated pet treat preferably is at least 20% of the animal's treat intake, more preferably at least 30% of the animal's treat intake, even more preferably at least 40% of the animal's treat intake, and most preferably at least 50% of the animal's treat intake. Preferably, the aerated treat of the present invention comprises 100% of the animal's daily treat intake. In an embodiment where the aerated pet treat is considered a meal for the pet, it is preferred that consumption of the aerated pet treat is preferably at least 20% of the animal's meal intake, more preferably at least 30% of the animal's meal intake, still more preferably at least 40% of the animal's meal intake, and most preferably at least 50% of the animal's meal intake. The ratio of treats made in accordance with the present invention and other commercial treats can be adjusted such that the caloric needs of the cat are equal to the caloric intake of the cat such that the weight is stabilized or controlled, and weight gain is slowed or eliminated. Of course, it will be appreciated that the treats of the present invention can be eaten in great quantities without significantly increasing the caloric intake of the cats, especially when consumption of these treats is substituted for other commercially available treats that are higher in calories. Thus, an individual that wants to reward their cat with treats now has a low calorie, highly palatable option that can be administered in much greater quantities than previously possible without greatly increasing the caloric intake of their cat and adversely affecting their health. Further, given the high protein content (as a percentage of the treat) of treats in accordance with the present invention, the treats can serve as a substitute for other food and/or treats that are high in, or primarily based carbohydrates, in order to reduce the overall percentage of the cat's diet that is carbohydrate and increase the percentage that is protein.

A further aspect of the present invention provides for a method for facilitating weight loss in an animal. The method preferably includes the steps of administering the aerated pet treat of the present invention to an animal in need thereof. Preferably, the aerated pet treat comprises at least 51% protein by weight and has a caloric density of less than about 3.0 calories per gram weight, where the pet treat of the present invention is normally less than 1 gram in weight. Generally, the treats of the present invention will take the place of other treats and/or food that would have been fed to the cat. Such a method utilizes the low caloric, low density properties of treats in accordance with the present invention and permits the animal to consume large volumes of the treats without a significant increase in caloric intake, especially when these treats are substituted for food and/or treats that are higher in calories and/or density.

As can be appreciated, both the methods for weight loss and the methods for weight control or stabilization can be utilized by pet owners that like to provide their pets with a large number of treats over the course of a day or week. As is known, many pets receive the correct amount of complete, nutritionally balanced pet feed to maintain their optimum weight. When these animals are also fed treats, whether it be to reward the pet for a desired behavior, or because the owner just enjoys providing the pet with something that they like to eat, their total caloric intake contains calories in excess of the amount needed to maintain optimum weight, thereby resulting in weight gain. Because the aerated treats of the present invention are so low in calories, both on a per treat and on a density basis, an owner can provide many treats to their pet and feel the satisfaction that comes with such actions without adversely increasing the caloric intake of the pet. This is especially true when the aerated treats are substituted for an equal volume or number of non-aerated treats. For example, if a certain pet behavior generally results in the owner providing a single treat, when a single aerated treat of the present invention is substituted therefore, the owner still receives the satisfaction of rewarding the pet, the pet is rewarded with the same number of treats that they are used to receiving and reinforcement of the behavior is continued, and the adverse effects from extra caloric intake (weight gain and all negative physical effects resulting therefrom) are avoided or minimized. The same is true if the traditional treat amount is measured by volume and an equal volume of aerated treat is substituted therefor.

In a preferred aspect of the present invention the small portions of the whipped composition can be formed into various shapes. The shapes can be formed manually or by machine. Preferably, the machine used is a depositor machine, such as the Polin Multidrop (Verona, Italy). Advantageously, a depositor avoids pressurization and compression of the foam and minimizes breakdown of the aerated surface. Any shape that is attractive to a pet will work for purposes of the present invention. Preferably, the small portions are shaped into a drop, a bone, a heart, a star, a prey animal, a sphere, a cube, a cuboid, and the like.

The heating step of the method of the present invention is operable to remove water and/or moisture from the composition as well as “setting” the treat into its desired shape. The heating can be carried out using any heat source which stabilizes foam-type compositions suitable for consumption by pets. Preferably, the heat source is selected from, but not limited to, a conventional oven, a vacuum oven, a super-heated steam oven, a gas fired drier, heated air streams, infrared heat systems, and a microwave oven. In a preferred embodiment, the temperature of the heat source is preferably about 100-140° C., more preferably between about 110-130° C., and most preferably, about 115° C.-125 C and the baking time is between about 5-45 minutes, between about 10-30 minutes, or between about 15-20 minutes. In one embodiment, the baking time is about 20 minutes.

The method of the present invention preferably includes a cooling step. The cooling step can be carried out using any cooling method known in the art appropriate for producing the aerated pet treat. Preferably, the cooling is accomplished using ambient temperature, forced air cooling, or combinations thereof. The cooling step preferably takes from about 1 to 40 minutes, more preferably from about 3 to 30 minutes, still more preferably, from about 5 to 25 minutes, more preferably from about 8 to 15 minutes, and most preferably, about 10 minutes.

In an alternate embodiment, the aerated pet treat, after cooling, may be subjected to the addition of coatings, such as, but not limited to, fats, flavorants, functional ingredients, nutraceuticals, vitamins, biological additives, heat sensitive ingredients, and combinations thereof. In a further embodiment, these coatings may be added to the pet treat prior to the heating step.

The whipping step for the methods of the present invention can be accomplished using any method that whips the ingredients forming air bubbles within. In a preferred embodiment, egg white, sugar, and a liquid are whipped to form a meringue composition. Preferably, the whipping step is accomplished using a method selected from, but not limited to, a bowl and a whipping blade; an aerator, or a continuous mixer. In a most preferred embodiment, the whipping step is accomplished using an aerator, such as an Oakes Continuous Mixer Aerator (Asser Oakes, Cheshire, England). In an embodiment where an aerator is used, the air flow in cubic feet per minute (ccm) generally ranges from about 0.0751 to 0.1328 ccm. Preferably, for a slurry of ingredients with a specific gravity of 1.2, the flow rate preferably ranges from 0.0774 ccm to 0.1259 ccm. Preferably, for a slurry of ingredients with a specific gravity of 1.1, the flow rate preferably ranges from 0.0751 ccm to 0.1255 ccm. Preferably, for a slurry of ingredients with a specific gravity of 1.3, the flow rate preferably ranges from 0.0794 ccm to 0.1328 ccm. Depending on the viscosity of the slurry, the settings for the aerator may vary in order to achieve an aerated product or foam. Preferably, the operating pressure is set to run at between 70-120 psi.

In an alternate embodiment, the methods of the present invention comprise the steps of combining water, glycerin and a flavorant or palatability enhancer, forming a liquid mix in a container; mixing the dry ingredients, including sugar and egg white powder in a separate container; mixing the liquid and dry ingredients together by slowly adding the liquid to the dry ingredients; aerating the mixed ingredient portions; dropping portions of the mixed ingredients onto a surface; and exposing the portions to heat. Preferably, when the liquid and dry ingredients are mixed, the liquid is added to the dry ingredients slowly in order to avoid rapid foaming during mixing. Aerating the dry and liquid ingredients preferably results in a foam composition. It is preferred that the mixed composition sits for 10-15 minutes prior to being exposed to the aerator. A depositor machine is preferably used to drop the aerated portions onto a surface. In some forms of the invention, the aerated composition is immediately formed into the desired shapes after aeration. In other forms of the invention, the aerated composition is transported to a holding container after aeration for subsequent formation into the desired shapes. In such an embodiment, the aerated portions are preferably transported to the depositor within approximately 10 minutes after aeration. The heating source used is preferably selected from a conventional oven, vacuum oven, steam oven, or a microwave oven.

In one embodiment, the aerated treat formulation comprises about 4% gelatin, 4% egg white, 3% flavorant, 8% wheat flour, 2% corn starch, 4% tapioca starch, 6% dextrose, 7% skim milk powder, 0.4% Xanthan Gum, 61.5% water, and 0.1% tartaric acid (pre-baking). In an alternate embodiment, the aerated treat formulation comprises 9% egg white, 4.5% gelatin, 4% animal plasma, 4.5% pea protein isolate, 9% corn syrup, 4.5% corn starch, 0.4% Xanthan gum, 0.10% tartaric acid, and 64% water (pre-baking).

### DESCRIPTION OF FIGURES

FIG. 1 is a photograph of the aerated pet treat of the present invention illustrating the preferred number of bubbles per mm².

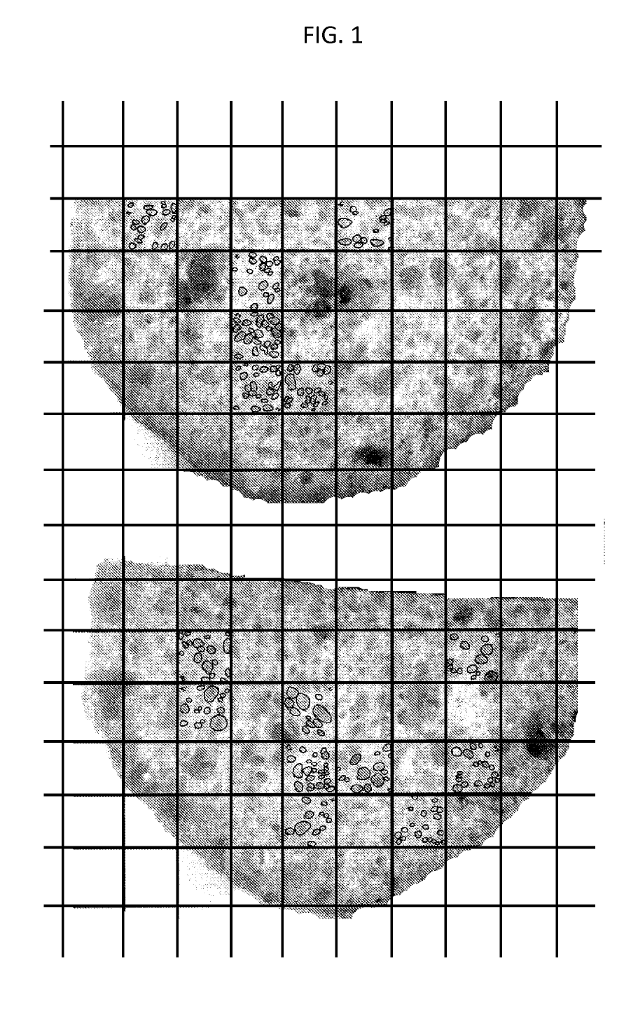

### DETAILED DESCRIPTION

### EXAMPLE 1

This example illustrates one embodiment of how to make the aerated pet treat of the present invention.

### Materials and Methods

Hydration of Ingredients:

Water, glycerin and flavorant in appropriate ratios (examples of ratios of ingredients as in Example 4) were first mixed well in a container. Next, all the dry ingredients/powders in appropriate ratios were collected and mixed well separately. Then the dry mix was added slowly into the liquid mixture while gently mixing the slurry as it is being formed. Mixing too rapidly while adding powders to the liquids can lead to foaming instantly and hence rapid mixing was avoided. The formed slurry was set aside for 10-15 minutes to let the ingredients hydrate before being subjected to aeration. An optimal amount of Air/Nitrogen was then added to the mixture:

TABLE 1
The air flow into the aerator calculations were as follows -

| | Flow | Flow | Air | Air |
|---|---|---|---|---|
| | Rate, | Rate, | Flow, | Flow, |
| | Kg/hr | lbs/hr | cfm | ccm |
| For slurry s.g. of 1.2 & foam s.g. of 0.3 | 88 | 194 | 0.1259 | 3565 |
| For slurry s.g. of 1.2 & foam s.g. of 0.3 | 66 | 145 | 0.0968 | 2741 |
| For slurry s.g. of 1.2 & foam s.g. of 0.3 | 52.8 | 116 | 0.0774 | 2191 |
| For slurry s.g. of 1.1 & foam s.g. of 0.3 | 88 | 194 | 0.1255 | 3553 |
| For slurry s.g. of 1.1 & foam s.g. of 0.3 | 66 | 145 | 0.0938 | 2651 |
| For slurry s.g. of 1.1 & foam s.g. of 0.3 | 52.8 | 116 | 0.0751 | 2126 |
| For slurry s.g. of 1.3 & foam s.g. of 0.3 | 88 | 194 | 0.1328 | 3760 |
| For slurry s.g. of 1.3 & foam s.g. of 0.3 | 66 | 145 | 0.0993 | 2812 |
| For slurry s.g. of 1.3 & foam s.g. of 0.3 | 52.8 | 116 | 0.0794 | 2248 |

cfm is cubic feet per minute
ccm is cubic centimeter per minute

Depending on the viscosity of the slurry, the settings of the motor and aerator may vary to achieve the foam. Hence the settings need to be set in such a way that the operating pressure is running at 70-90 psi.

In order to deposit the foam using a depositor machine, the foam should be transported to the depositor or deposited within approximately 10 minutes after the foam is formed if a batch process with a storage time is used. Alternatively, as was done in this Example, continuous flow of the aerated foam from the aerator to the depositor was carried out.

### Results and Conclusion

This method produced an aerated pet treat that is low in fat and calories. The density of the aerated pet treat was approximately 0.284 g/cc to 0.345 g/cc. The aerated pet treat made by this method comprises from about 4.5% to 20% protein, 4.5% to 20% sugar, 30% to 80% liquid, and 20% to 60% other ingredients, prior to heating. Preferably, the protein is egg white, the sugar is glycerin, the liquid is water, and the other ingredients include a flavorant, a preservative, and a stabilizer. After being mixed, deposited and heated, the resulting aerated pet treat preferably contains at least 51% protein, at least 2.5% fat, less than 0.5% fiber, and less than 7.6% moisture.

### EXAMPLE 2

This example illustrates one method of weight loss using the present invention.

### Materials and Methods

A group of cats that are at least 10% over their ideal body weight will be divided into several test groups and a control group. The normal volume of nutritionally complete pet feed and treat intake per cat will be known prior to testing. Cats in the control group will receive their normal volume of pet feed and will also receive their normal volume of treats and will not receive any aerated treats. Test groups will receive their normal volume of pet feed and their normal volume of pet treats. For the test groups, the ratio of the volume of treats received by each group will be a combination of treats made in accordance with the present invention and their normal treats. In other words, if a cat normally receives 100 cc volume of treats/day, that volume will be split between aerated treats in accordance with the present invention and “normal” treats. The ratios for the groups will be as follows: (expressed as a ratio of aerated treats/normal treats) Group 1 will receive a 20/80 ratio, Group 2 will receive a 60/40 ratio, Group 3 will receive a 80/20 ratio, and Group 4 will have a 100/0 ratio (i.e. all of their treats will be aerated). The weight of each animal in the study will be taken at Day 0 of the study and then every 7 days thereafter.

### Results and Conclusions

The results will show that the cats in the test groups will lose weight over the 14 day period when compared to the cats in the control group, which will either maintain a constant weight, or will gain weight. Further, as the ratio of aerated treats increases, the weight loss will be accelerated and more pronounced.

### EXAMPLE 3

This example illustrates one method for losing, controlling or stabilizing weight while still providing a pet a high number of treats using the present invention.

### Materials and Methods

A group of cats that are within 2% of their ideal body weight will be divided into 3 aerated treat test groups, a meat treat test group, and a control group. The aerated pet treat of the present invention will be administered to the aerated treat test groups. Meat-based treats, such as jerky, will be administered to the meat treat test group. All animals will also be fed the recommended amount of a nutritionally complete pet feed on a daily basis. Cats in the aerated treat test groups will receive 10, 20, and 30 aerated treats, respectively, on a daily basis. Cats in the meat treat test group will receive 10 meat-based treats daily, and cats in the control group will not receive any treats. The weight of each animal in the study will be taken at Day 0 of the study and every 7 days thereafter.

### Results and Conclusions

The results will show that the cats in the aerated treat test groups will maintain their weight when compared to the cats in the control test group, whereas animals in the meat treat test group will gain weight over time due to the increased caloric intake of the treats. Accordingly, cats receiving aerated treats will be able to receive treats and be rewarded without the adverse effects of increased caloric intake (over the recommended daily caloric intake) and all of the problems associated with being overweight and/or obese. Similarly, owners that enjoy providing their cats with a number of treats over the course of a day will be able to provide that number of treats without subjecting the cat to unnecessary calories and subsequent weight gain.

### EXAMPLE 4

This example illustrates the palatability of the aerated pet treat and the attractive nature of the pet treat to cats.

### Materials and Methods

40 cats were placed in a room with a bowl containing the aerated pet treat of the present invention and a bowl containing a commercial cat treat. The cats were left to consume the pet treats for 10 minutes and then again for 1 hour. This test was repeated five different times with aerated treats having 2 different consistencies—crunchy and soft—and two different commercial crunchy treats and three commercial soft treats. The amount (number) of treats in each bowl was measured prior to the study and after the study was completed. The amount consumed was then determined.

### Results and Conclusions

TABLE 2
Crunchy commercial treats compared to crunchy aerated treats

| | | | |
|---|---|---|---|
| 10 | Aerated Treat | vs.* | Pounce ® Crunchy |
| minutes | 63.4 | | 36.6 |
| | Aerated Treat | vs.* | Party Mix ™ |
| | 58.9 | | 41.1 |
| 1 hour | Aerated Treat | vs.* | Pounce ® Crunchy |
| | 64.3 | | 35.7 |
| | Aerated Treat | vs.* | Party Mix ™ |
| | 58.9 | | 41.1 |

TABLE 3
Soft treat commercial treats compared to soft aerated treats

| | | | |
|---|---|---|---|
| 10 | Aerated Treat | vs.* | Pounce ® Moist |
| minutes | 73.4 | | 26.6 |
| | Aerated Treat | vs.* | Whisker Lickins ® Semi |
| | 64.9 | | Moist |
| | | | 35.1 |
| | Aerated Treat | vs. | Temptations ® |
| | 54.9 | | 45.1 |
| 1 hour | Aerated Treat | vs.* | Pounce ® Moist |
| | 73.4 | | 26.6 |
| | Aerated Treat | vs.* | Whisker Lickins ® Semi |
| | 64.9 | | Moist |
| | | | 35.1 |
| | Aerated Treat | vs. | Temptations ® |
| | 54.9 | | 45.1 |

As illustrated above, the aerated treat was preferred over all commercial treats in both the crunchy and soft commercial studies. Accordingly, the aerated pet treat of the present invention has increased palatability for cats.

### EXAMPLE 5

This example illustrates the palatability of the aerated pet treat to cats and that cats really enjoy the aerated treat

### Materials and Methods

40 cats were given the aerated pet treat of the present invention for 2 days non-consecutively and for 2 days consecutively. Each cat had access to 12 treats per day. This was completed twice, once for a crunchy version of the aerated treat and once for a soft version of the aerated pet treat. The amount of treats consumed was recorded.

### Results and Conclusions

TABLE 4
Results for crunchy treat

| 20 cats for 2 days | 10 minutes | 1 hour |
|---|---|---|
| 1 + 1 days (individual) | 90% | 92.50% |
| 2 days (combined) | 95% | 95% |

32 out of 40 cats consumed 100% of the treats in 10 minutes. 4 out of 40 cats did not consume any of the treats.

TABLE 5
Results for soft treat

| 20 cats for 2 days | 10 minutes | 1 hour |
|---|---|---|
| 1 + 1 days (individual) | 85% | 92.50% |
| 2 days (combined) | 95% | 95% |

33 out of 40 cats consumed 100% in 10 minutes. 6 out of the 40 cats did not try any of the treats.

### EXAMPLE 6

This example illustrates one embodiment of the pet treat of the present invention.

### Materials and Methods

The following ingredients were divided into dry and liquid ingredients, with a container for each. Each set of ingredients was mixed in its respective container. The ingredients were as follows:

TABLE 6
Ingredients

| | % Pre | % After |
|---|---|---|
| Ingredients | Baked | Baking |
| Gelatin | 4 | 10.4 |
| Dried Egg White | 4 | 10.4 |
| Flavorant | 3 | 7.8 |
| Wheat Flour | 8 | 20.8 |
| Corn Starch (Mira- | 2 | 5.2 |
| Gel ®) | | |
| Tapioca Starch | 4 | 10.4 |
| Dextrose | 6 | 15.6 |
| Skim Milk Powder | 7 | 18.2 |
| Xanthan Gum | 0.4 | 1.0 |
| Water | 61.5 | 0.0 |
| Tartaric Acid | 0.1 | 0.3 |
| | 100 | 100 |

The liquid ingredients were then slowly poured into the dry ingredients. The mixture of liquid and dry ingredients was then transferred to a holding hopper close to the mixing mechanism and held for approximately 15 minutes. The mixing mechanism, a continuous mixer, was then used to aerate the mixture. The aerated mixture was then put into another holding hopper for no more than 10 minutes. The aerated mixture was then fed into a depositor machine which deposited drops of the mixture onto a surface. The deposited mixture was then baked using a gas fired drier for 20 minutes at 119° C. The heated mixture was then let to cool at ambient temperatures for 20 minutes.

### Results and Conclusions

The method above resulted in a meringue-type treat that is light and attractive to pets. The pet treat had a protein content of at least 51%, a fat content of about 2.5%, a fiber content of about 0.5%, and a moisture content of about 7.6%. The density of the treat was between 0.284 g/cc and 0.345 g/cc.

### EXAMPLE 7

This example illustrates one embodiment of the pet treat of the present invention.

### Materials and Methods

The following ingredients were divided into dry and liquid ingredients, with a container for each. Each set of ingredients was mixed in their respective container. The ingredients were as follows:

TABLE 7
Ingredients
Foam Product

| | % Pre- | % Post- |
|---|---|---|
| Ingredients | Baking | Baking |
| Egg White, dried | 9.00 | 25.00 |
| Gelatin (100 Bloom) | 4.50 | 12.50 |
| Animal Plasma, dried | 4.00 | 11.11 |
| Pea Protein Isolate | 4.50 | 12.50 |
| Corn Syrup | 9.00 | 25.00 |
| Corn Starch (Mira- | 4.50 | 12.50 |
| Gel ®) | | |
| Xanthan Gum | 0.40 | 1.11 |
| Tartaric Acid | 0.10 | 0.28 |
| Water | 64.00 | 0 |
| | 100 | 100 |

Dry digest, ACPF2, is sprinkled lightly over product prior to baking.

The liquid ingredients were then slowly poured into the dry ingredients and mixed together. The mixture of liquid and dry ingredients was then transferred to a holding hopper close to the mixing mechanism for approximately 10-15 minutes. The mixing mechanism, a continuous mixer, was then used to aerate the mixture. The aerated mixture was then put into another holding hopper for no more than 10 minutes. The aerated mixture was then manually deposited onto a surface. The deposited mixture was then baked using a gas fired drier for 20 minutes at 119° C. The heated mixture was then let to cool at ambient temperatures for 20 minutes.

### Results and Conclusions

The method above resulted in a meringue-type treat that is light and attractive to pets. The pet treat had a protein content of at least 51%, a fat content of about 2.5%, a fiber content of about 0.5%, and a moisture content of about 7.6%. The density of the treat was between 0.284 g/cc and 0.345 g/cc.

### EXAMPLE 8

This example illustrates one embodiment of the pet treat of the present invention.

### Materials and Methods

The following ingredients were divided into dry and liquid ingredients, with a container for each. Each set of ingredients was mixed in their respective container. The ingredients were as follows:

TABLE 8
Ingredients

| | Crunchy | Soft |
|---|---|---|
| | % Pre- | % Post- |
| Ingredients | Baking | Baking |
| Egg White, dried | 14.00 | 11.40 |
| Animal Plasma, dried | 4.00 | 4.50 |
| Pea Protein Isolate | 4.00 | 4.50 |
| Flavorant | 4.00 | 4.50 |
| Wheat Flour | 4.00 | 3.00 |
| Glycerine | 5.00 | 14.00 |
| Corn Starch (Mira- | 4.00 | 3.00 |
| Gel ®) | | |
| Xanthan Gum | 0.50 | 0.50 |
| Tartaric Acid | 0.10 | 0.10 |
| Water | 60.40 | 54.50 |
| | 100 | 100 |

The liquid ingredients were then slowly poured into the dry ingredients and mixed together. The mixture of liquid and dry ingredients was then transferred to a holding hopper close to the mixing mechanism for 10-15 minutes. The mixing mechanism, a continuous mixer, was then used to aerate the mixture. The aerated mixture was then put into another holding hopper for no more than 10 minutes. The aerated mixture was then manually deposited onto a surface. The deposited mixture was then baked using a gas fired drier for 20 minutes at 119° C. The heated mixture was then let to cool at ambient temperatures for 20 minutes.

### Results and Conclusions

The method above resulted in a meringue-type treat that is light and attractive to pets. The pet treat had a protein content of at least 51%, a fat content of about 2.5%, a fiber content of about 0.5%, and a moisture content of about 7.6%. The density of the treat was between 0.284 g/cc and 0.345 g/cc.

### EXAMPLE 9

This example illustrates another embodiment of the present invention.

### Materials and Methods

The ingredients were added as described in Examples 6-8. A critical element of hydrating the ingredients was the avoidance of foam and preventing the agglomeration of clumps that are hard to dissolve. The ingredients were slowly dispersed in the solvent and slow counter flow mixing is typically used to help disperse the ingredients.

Hydration of Ingredients:

Water, glycerin and a flavorant in appropriate ratios (examples of ratios of ingredients can be found in Example 4) were first mixed well in container. Next, all the dry ingredients/powders in appropriate ratios were collected and mixed well separately. Then the dry mix was added slowly into the liquids while gently mixing the slurry under low shear conditions as it was being formed. Mixing too rapidly while adding powders to the liquids can lead to foaming instantly and hence rapid mixing is avoided. Slow counterflow mixing was utilized to fully mix the composition. The formed slurry was then set aside for 10-15 minutes to let the ingredients hydrate before subjecting it to aeration.

The mixture was transferred into a holding hopper close to the foaming system, where it was pumped into the foamer at a speed setting of between 20-40 RPM. The aerator rotor speed was set to between 350-700rpm with a preferred setting of 500. These settings are variable within the provided range depending upon the viscosity and specific gravity of the mixture.

Depending on the viscosity of the slurry, the settings of the motor and aerator may vary to achieve a foam with the desired characteristics. Hence the settings need to be set in such a way that the operating pressure (noted from the pressure gauge mounted prior to the mixer on the Oakes Continuous Aerator machine) is running at 70-90 psi.

Optimal Amount of Air/Nitrogen that is Added to the Mixture:

TABLE 9
the air flow into the aerator calculations were as follows:

| | Flow | Flow | Air | Air |
|---|---|---|---|---|
| | Rate, | Rate, | Flow, | Flow, |
| | Kg/hr | lbs/hr | cfm | ccm |
| For slurry s.g. of 1.2 & foam s.g. of 0.3 | 88 | 194 | 0.1259 | 3565 |
| For slurry s.g. of 1.2 & foam s.g. of 0.3 | 66 | 145 | 0.0968 | 2741 |
| For slurry s.g. of 1.2 & foam s.g. of 0.3 | 52.8 | 116 | 0.0774 | 2191 |
| For slurry s.g. of 1.1 & foam s.g. of 0.3 | 88 | 194 | 0.1255 | 3553 |
| For slurry s.g. of 1.1 & foam s.g. of 0.3 | 66 | 145 | 0.0938 | 2651 |
| For slurry s.g. of 1.1 & foam s.g. of 0.3 | 52.8 | 116 | 0.0751 | 2126 |
| For slurry s.g. of 1.3 & foam s.g. of 0.3 | 88 | 194 | 0.1328 | 3760 |
| For slurry s.g. of 1.3 & foam s.g. of 0.3 | 66 | 145 | 0.0993 | 2812 |
| For slurry s.g. of 1.3 & foam s.g. of 0.3 | 52.8 | 116 | 0.0794 | 2248 |

cfm is cubic feet per minute
ccm is cubic centimeter per minute

The aerated material was then directed to a holding hopper with a maximum holding time of 10 minutes and then directed to a depositing machine. In order to deposit the foam using a depositor machine, the foam needed to be transported to the depositor within approximately 10 minutes after the foam is formed in a batch. Continuous flow of foam from aerator to depositor is preferred and was used here. The depositor was used because it avoids pressurization and compression of the foam to minimize breakdown of the aerated structure.

The foam was then baked by being deposited onto a belt prior to entry into the drier. Some of the treats had functional ingredients, such as palatants, flavor development ingredients, or vitamins, added to them prior to baking. The treats were then dried/baked for 20 minutes at 110-120° C. using a gas fired drier. Heated air streams, infrared or microwave could also have been used.

Next, the treats were cooled using ambient cooling for 20 minutes. Once cooled, some of the treats produced were subjected to the addition of coatings, such as fats or flavorants, functional ingredients, such as vitamins, microbiological additives, heat sensitive ingredients, etc.

### Results and Conclusions

The method above resulted in a meringue-type treat that is light and attractive to pets. The pet treat had a protein content of at least 51%, a fat content of about 2.5%, a fiber content of about 0.5%, and a moisture content of about 7.6%. The density of the treat was between 0.284 g/cc and 0.345 g/cc.

1. A pet treat comprising respective amounts of a protein source and a carbohydrate, wherein said pet treat has less than about 5 calories per gram weight.

2. A low calorie pet treat comprising a protein source and carbohydrate, wherein said pet treat has a caloric density of less than about 3.5 calories per gram weight.

3. The low calorie pet treat of claim 2, wherein said treat is further characterized by having a moisture content of less than about 7.6% by weight.

4. The low calorie pet treat of claim 2, wherein said treat is further characterized by having a fat content of less than about 2.5% by weight.

5. The low calorie pet treat of claim 2, wherein said treat is further characterized by having a protein content of at least about 51%.

6. The low calorie pet treat of claim 2, wherein said protein source includes egg.

7. The low calorie pet treat of claim 2, wherein said treat is further characterized by having at least 11 to 23 air bubbles per mm² within the structure of said treat.

8. An aerated pet treat comprising respective amounts of a protein source and a sugar, wherein said pet treat has less than about 3 calories per gram weight.

9. An aerated pet treat comprising a protein source and sugar, wherein said pet treat has a bulk density from about 0.345 g/cc to 0.284 g/cc.

10. The aerated pet treat of claim 9, wherein said treat is further characterized by having a moisture content of less than about 7.6% by weight.

11. The aerated pet treat of claim 9, wherein said treat is further characterized by having a fat content of less than about 2.5% by weight.

12. The aerated pet treat of claim 9, wherein said treat is further characterized by having a protein content of at least about 51%.

13. The aerated pet treat of claim 9, wherein said protein source includes egg.

14. The aerated pet treat of claim 9, wherein said treat is further characterized by having at least 11 to 23 air bubbles per mm² within the structure of said treat.

15. A low fat pet treat comprising a protein source and sugar, wherein said pet treat has a fat content of less than about 2.5%.

16. A low fat pet treat comprising a protein source and sugar, wherein said pet treat has a caloric density of less than about 3.0 calories per gram weight and has a bulk density from about 0.345 g/cc to 0.284 g/cc.

17. The low fat pet treat of claim 16, wherein said treat is further characterized by having a moisture content of less than about 7.6% by weight.

18. The low fat pet treat of claim 16, wherein said treat is further characterized by having a protein content of at least about 51%.

19. The low fat pet treat of claim 16, wherein said protein source includes egg.

20. The low fat pet treat of claim 16, wherein said treat is further characterized by having at least 11 to 23 air bubbles per gram within the structure of said treat.

21. A method for controlling weight in an animal comprising administering to said animal a pet treat comprising at least about 51% protein by weight and having a caloric density of less than about 3.0 calories per gram weight.

22. A method for controlling weight in an animal comprising administering to said animal a pet treat comprising at least about 51% protein by weight and having a caloric density of less than about 3.0 calories per gram weight, wherein said pet treat accounts for 20% of the volume of food consumed by said animal.

23. A method for controlling weight in an animal comprising administering to said animal a pet treat comprising at least about 51% protein by weight, having a caloric density of less than about 4.5 calories per gram weight, and having a fat content of less than about 2.5%, wherein said pet treat accounts for 20% of the volume of food consumed by said animal.

24. A method for controlling weight in an animal comprising the steps of:
a. whipping a composition comprising a protein source and a carbohydrate such that air bubbles form;
b. dropping said composition onto a surface in small portions;
c. heating said small portions such that said composition stabilizes resulting in a baked pet treat;
wherein the resultant pet treat has a protein content of at least about 51% by weight, a bulk density from about 0.345 g/cc to 0.284 g/cc, a moisture content of less than about 7.6% by weight, and having a caloric density of less than about 4.0 calories per gram weight; and
d. administering said pet treat to an animal in need thereof.

25. The method of claim 24, wherein said whipping step is accomplished using a bowl and a whipping blade.

26. The method of claim 25, wherein said whipping step takes about 1 to 3 minutes

27. The method of claim 24, wherein said whipping step is accomplished using a continuous mixer.

28. The method of claim 27, wherein said continuous mixer is used for about 1 to 3 minutes.

29. The method of claim 24, wherein said whipping step is accomplished using an aerator.

30. The method of claim 29, wherein said aerator has an air flow from about 2191 ccm to about 3760 ccm.

31. The method of claim 24, wherein said dropping step includes manually shaping said small portions.

32. The method of claim 24, wherein said heating step includes the use of a heating source selected from the group consisting of a conventional oven, vacuum oven, super-heated steam oven, and microwave oven.

33. A method for weight loss in an animal comprising administering to said animal a pet treat comprising at least about 51% protein by weight and having a caloric density of less than about 5.0 calories per gram weight.

34. The method of claim 33, wherein the pet treat comprises at least 50% of the animal's daily treat intake

35. A method for weight loss in an animal comprising administering to said animal a pet treat comprising at least about 51% protein by weight and having a caloric density of less than about 3.1 calories per gram weight, wherein said pet treat accounts for 20% of the volume of food consumed by said animal.

36. A method for weight loss in an animal comprising administering to said animal a pet treat comprising at least about 51% protein by weight, having a caloric density of less than about 4.0 calories per gram weight, and having a fat content of less than about 2.5%, wherein said pet treat accounts for 20% of the volume of food consumed by said animal.

37. A method for weight loss in an animal comprising the steps of:
a. whipping a composition comprising a protein source and a sugar such that air bubbles form;
b. dropping said composition onto a surface in small portions;
c. heating said small portions such that said composition stabilizes resulting in a baked pet treat;
wherein the resultant pet treat has a protein content of at least about 51%, a bulk density from about 0.345 g/cc to 0.284 g/cc, a density less than about 0.01 g/cc, a moisture content of less than about 7.6% by weight, and having a caloric density of less than about 5.0 calories per gram weight; and
d. administering said pet treat to an animal in need thereof.

38. A pet treat, comprising a chewy outer portion and a crunchy inner portion, wherein said pet treat is comprised of a protein source and sugar that is whipped such that air bubbles form within said treat

39. A pet treat, comprising a chewy outer portion and a crunchy inner portion, wherein said pet treat is comprised of a protein source and sugar, wherein the bulk density is from about 0.345 g/cc to 0.284 g/cc, the moisture content is less than 10% by weight, and the caloric density is 2.5 to 5.0 calories per gram weight.

40. A method of cleaning the teeth of an animal comprising the step of administering a treat having a body including an outer and an inner layer, wherein said outer layer remains in contact with the surface of a tooth for at least 40% of the closing mastication movement of a bite prior to detaching from said treat body and wherein said body has a caloric density of less than about 3.2 calories per gram weight.

41. A pet treat comprising respective amounts of a protein source and a carbohydrate, wherein said pet treat has less than about 1 calories per treat.

42. A pet treat comprising a protein source and carbohydrate, wherein said pet treat has less than about 1.0 calories per treat and has a bulk density from about 0.345 g/cc to 0.284 g/cc.

43. A pet treat comprising a protein source and a carbohydrate, wherein said pet treat has less than about 1.0 calories per treat and from about 11 to 23 bubbles per mm².

44. A pet treat comprising a protein source and a carbohydrate, wherein said pet treat has less than about 1.0 calories per treat, from about 11 to 23 bubbles per mm², and a bulk density from about 0.345 g/cc to 0.284 g/cc.
